(19) United States
(12) Patent Application Publication
(10) Pub. No.: US 2022/0022308 A1
(43) Pub. Date: Jan. 20, 2022

(54) Elongated Non-Thermal Plasma Reactor For Optimal Coupling To Pulsed Power Supply

(71) Applicant: ABB Schweiz AG, Baden (CH)

(72) Inventors: Jan CARSTENSEN, Waldshut-Tiengen (DE); Frank KASSUBEK, Rheinfelden (DE); Angelos GARYFALLOS, Niederrohrdorf (CH)

(21) Appl. No.: 17/311,533

(22) PCT Filed: Dec. 13, 2019
(86) PCT No.: PCT/EP2019/085082

§ 371 Date: Jun. 7, 2021

(30) Foreign Application Priority Data
Dec. 14, 2018 (EP) 18212650.8

(51) Int. Cl. H05H 1/24; H05H 1/03

(52) U.S. Cl. CPC H05H 1/2418; H05H 2242/20; H05H 1/03

(57) ABSTRACT

A plasma reactor for a Dielectric Barrier Discharge (DBD) system, the system includes one or more plasma reactor modules, the one or more plasma modules are configured as transmission lines. A duration of a rise-time and/or a fall-time of a voltage pulse, fed into a first end of the one or more reactor modules is shorter than a run-time of the voltage pulse from a first end of the one or more reactor modules to a second end of the one or more reactor modules.

### TECHNICAL FIELD

Embodiments of the present disclosure generally relate to generation of plasma with the method of dielectric barrier discharge. In particular, the current disclosure provides a scalable plasma reactor for a dielectric barrier discharge, using non-thermal plasma, with a propagating dielectric barrier discharge region to couple it to a pulsed power supply in an optimized way.

### BACKGROUND

Dielectric barrier discharges (DBD) are frequently used in industrial applications for the generation of chemical species, like chemical radicals, that can be used, among others, for disinfection and cleaning of surfaces or liquids. Dielectric barrier discharges have e.g. been applied as source for reactive chemical species for the treatment of ballast water.

Large scale DBD reactors, e.g., for the production of ozone, are usually operated with a low-frequency ac-voltage. DBD reactors may be operated at high voltages in the range of 1 kV to 100 kV.

There are two main types of voltage waveforms: A slow sinusoidal ac waveform, commonly used for commercial applications, with frequencies between 10 Hz and 10,000 Hz and a pulse train shaped waveform consisting of short, preferably rectangular shaped voltage pulses with a fast rise-time (<100 ns).

For large-scale commercial DBD reactors, e.g. used for decontaminating ballast water in ships, a high efficiency for the conversion of electrical energy into active species e.g. activated gases, is desirable.

It is known, that using short pulses for the conversion of electrical energy into active species is more efficient compared to an operation with a low-frequency ac voltage. Most large-scale commercial DBD-reactors are operated with a low-frequency ac voltage and do not exploit the benefit from a pulsed operation.

This is partly because large DBD reactors have a high electrical capacitance, like a big capacitor, and therefore require a high current, due to displacement current, to achieve fast rise-times.

However, the switching of high currents at high voltages is technically much more challenging than applying a slow ac voltage.

This is partly because of the following reasons: For industrial applications, large amounts of O3 (or other species) require a large DBD plasma reactor with a large area and therefore a large capacitance. A large electrical capacitance requires a high current to achieve fast risetimes.

It is known that a small rise-time, which means a large differential value dU/dt, can increase the efficiency of the discharge (e.g. an ozone (O3) production). But switching high currents at high voltages is technically much more challenging than applying a slow ac voltage.

High risetimes cannot be applied at high capacity as the currents become too large either for the power supply or for the cable (as its impedance will limit the current). Pulse trains are therefore currently only applied to small academic reactors.

In document “A Novel All Solid-State Sub-Microsecond Pulse Generator for Dielectric Barrier Discharges” by JUNFENG RAO ET AL; IEEE TRANSACTIONS ON PLASMA SCIENCE. IEEE SERVICE CENTER, PISCATAWAY, N.J., US, vol. 41, no. 3, 1 Mar. 2013 (2013 Mar. 1), pages 564-569, XP011495310, a solid state pulse generator for exciting continuous DBD in a few microseconds is disclosed.

This generator consists of a MARX generator, Blumlein transmission lines and one magnetic switch. As a power supply the all solid state MARX generator can output nanosecond-pulses with a voltage peak of up to 20 kV. The Blumlein transmission lines are charged by the MARX generator.

A DBD reactor in form of a capacity is arranged between two Blumlein transmission lines. The transmission lines may serve as energy storage for the pulse from the pulse generator. The DBD reactor in this configuration is however from the capacitive type, which has drawbacks when switching with very fast (rectangular shaped) pulses (high risetimes).

The present applications therefore provides a way to overcome this limitation and seeks to provide an efficient way to operate a large DBD reactor with high-voltage pulse supplies with fast rise-times to avoid losses of energy caused by reflections.

### SUMMARY

In order to address the foregoing and other potential problems, in a first aspect of the present application, a plasma reactor for a Dielectric Barrier Discharge (DBD) system is disclosed.

The plasma reactor may comprise one or more plasma reactor modules, wherein the io one or more plasma modules are configured as transmission lines. A duration of a rise-time and/or a fall-time of a voltage pulse, fed into a first end of the one or more reactor modules is shorter than a run-time of the voltage pulse from a first end of the one or more reactor modules to a second end of the one or more reactor modules.

### BRIEF DESCRIPTION OF DRAWINGS

Embodiments of the present disclosure will be presented in the sense of examples and their advantages may be explained in greater detail below, with reference to the accompanying drawings, wherein:

FIG. 1 shows a sketch of a plasma reactor module according to embodiments of the application;

FIG. 2 shows a sketch of an electrical circuit according to embodiments of the application;

FIG. 3 shows a pulsed voltage waveform as measured at an input and an output a of a reactor according to embodiments of the application;

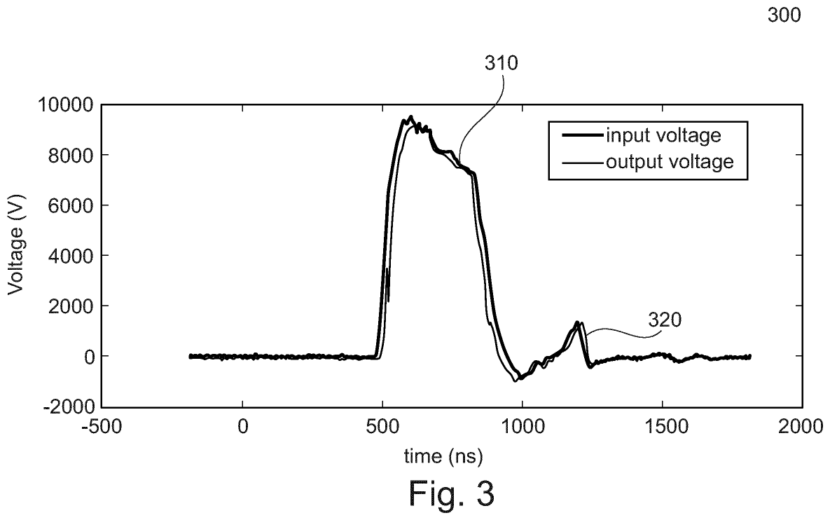

FIG. 4a shows an example of variants for a gas flow inside a plasma reactor module according to embodiments of the application;

FIG. 4b shows an example of variants for a gas flow inside a reactor according to embodiments of the application;

FIG. 4c shows an example of variants for a gas flow inside a plasma reactor module according to embodiments of the application.

### DETAILED DESCRIPTION

Hereinafter, the principle and spirit of the present disclosure will be described with reference to the illustrative embodiments. It should be understood, all these embodiments are given merely for the skilled in the art to better understand and further practice the present disclosure, but not for limiting the scope of the present disclosure. For example, features illustrated or described as part of one embodiment may be used with another embodiment to io yield still a further embodiment.

In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The disclosed subject matter will now be described with reference to the attached figures. Various structures, systems and devices are schematically depicted in the drawings for purposes of explanation only and so as to not obscure the description with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase may be intended to have a special meaning, i.e., a meaning other than that understood by skilled artisans, such a special definition will be expressly set forth in the specification in a definitional manner that directly and unequivocally provides the special definition for the term or phrase.

In this application, a reactor design for a Dielectric Barrier Discharge system is disclosed that may solve drawbacks and problems of current systems and which enables an energy efficient operation of large-scale DBD-reactors with pulsed voltage waveforms. A dielectric barrier discharge DBD requires an electrode pair, preferably separated by a dielectric material and a discharge gap. The discharge gap may be arranged between the electrodes. The gap may be partially filled with the dielectric material.

The dielectric may be also a dielectric layer on one of the electrodes. The dielectric layer material may also be arranged on both electrodes. r may be arranged on. In a classical design, these electrodes may be designed as pure capacitors. Transient effects of the voltage io pulse traveling along the electrode may not play a crucial role in such an arrangement.

The approach presented here in the present application, may now change the design of electrodes such, that a transient electric pulse travels along the electrodes (similar to transmission lines).

In particular, the reactor may have an electrode design that which is “elongated”. That means, the electrodes substantially extend in the direction of the propagation of the electrical pulse. For coupling electric pulses into the reactor, the reactor is only characterized by its impedance (which can be adapted by changing the cross-section geometry), and not by the total capacity

Instead of being designed to drive a large capacitive load current as it is for a standard system (slow ac, large reactor), an electrical system power for operating a plasma reactor according to the present application (pulsed, long reactor) should preferably be designed for a characteristic wave impedance of the reactor for a dielectric barrier discharge.

The present application may allow to operate a DBD reactor, in particular a large-scale scale DBD reactor, with a pulsed voltage waveform that is characterized by short rise- and fall times of less than 100 ns. The conversion of electrical energy into active species may be more efficient for a pulsed operation of the reactor, compared to an operation with a slow ac voltage. The presented layout of the reactor geometry may be easily scaled to different sizes of plasma reactors, e.g. by simply changing the length of the reactor, to generate a predetermined amount of active species required by the respective application.

A geometry of the DBD reactor may be chosen in a way that a length in one direction is comparable with the physical length of the voltage pulse. That means, in case the length of the voltage pulse is physically 2 m for example, the DBD reactor may also have a length of 2 m. Other relations of pulse lengths and reactor lengths are possible. A pulse length can e.g. also be two times the reactor length.

A specific diameter or cross-section of the DBD reactor may be also be determined accordingly. A larger diameter or cross-section influences an amount of treatable gas and also the characteristic impedance.

In a first embodiment of the present application a plasma reactor for a Dielectric Barrier Discharge (DBD) system is disclosed. The plasma reactor may comprise one or more io plasma reactor modules, wherein the one or more plasma modules are configured as transmission lines. That means, the modules have a characteristic impedance. Further, a duration of a rise-time and/or a fall-time of a voltage pulse, fed into a first end of the one or more reactor modules is shorter than a run-time of the voltage pulse from a first end of the one or more reactor modules to a second end of the one or more reactor modules.

The plasma reactor modules in the disclosed plasma reactor may be configured to be electrically connected to a series connection to provide a scalable plasma reactor. That means, two or more such plasma reactor modules or, with another expression, plasma reactor elements can be connected. The connection can be a series connection or a parallel connection.

The length of the reactor l may be determined by the requirements of the respective application. Requirements of the application can be e.g. a concentration and amount of an active species and a total required gas-flow. A pulse duration tₚᵤₗₛₑ and a rise time tᵣᵢₛₑ of the pulse may preferably be chosen such, that 10l>vₚᵤₗₛₑtₚᵤₗₛₑ>1 l and vₚᵤₗₛₑtᵣᵢₛₑ <1 l. vₚᵤₗₛₑ is the velocity of the pulse. This consideration is applicable on the complete reactor length or the length of a single reactor element. A plasma reactor may at least comprise one module. vₚᵤₗₛₑ is the propagation speed of the voltage pulse in the DBD reactor. Furthermore, C′ and L′ are a capacitance and an inductance per unit length of a DBD reactor. The values are necessary to determine a characteristic impedance of the cable 210.

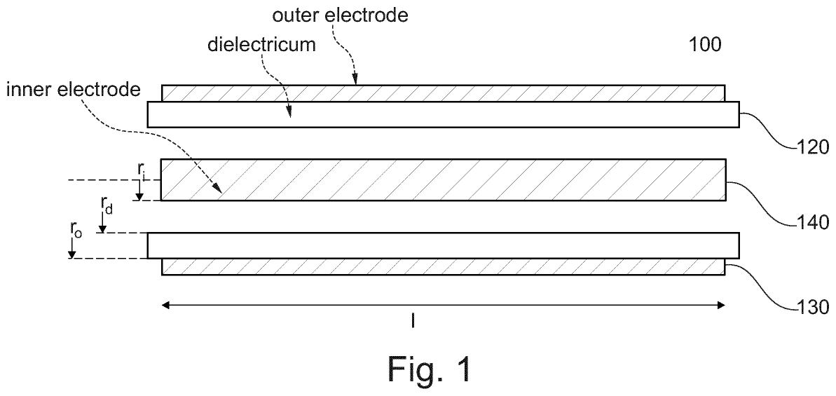

In the simplified case of a concentric arrangement as in FIG. 1, C′ is determined by the equation C′=2π∈₀[1/∈ log(rₒ/r_{d})+log(r_{d}/rᵢ)]⁻¹ and L′ is determined by the equation L′=μ₀/2πlog(rₒ/rᵢ).

It is therein ∈₀ the vacuum permeability, E the relative permittivity of the dielectric, rᵢ the radius of inner electrode (the inner core electrode in a coaxial arrangement), r_{d} the inner radius of the dielectric, and r₀ the outer radius of the dielectric and the inner radius of the outer electrode.

The dimensions of the plasma reactor (distance between electrodes, thickness of the dielectric, discharge gap) may preferably be chosen in a way that a wave impedance of the reactor (Z_{reactor}=\sqrt{L′/C′}) may be equal to the wave impedance of a connection cable 210 or may preferably be in the range of 0.5*Z_{cable}<Z_{reactor}<2*Z_{cable}.

One preferred realization of such a DBD reactor is sketched in FIG. 1. The inner electrode 140, the dielectric 120 and the outer electrode 130 may be arranged in a coaxial manner. The application is however not limited to such coaxial arrangements. Alternative solutions wherein reactor modules have a predetermined characteristic impedance but are not coaxial may be also covered by the application.

A characteristic impedance at a first end of a rector module may be different to a characteristic impedance at a second side of the reactor module. The same may apply to connection cables. A matching between different characteristic impedances may be achieved.

A discharge gap, wherein plasma is generated during operation, may be arranged between one of the electrodes 120, 140 and the dielectric 120.

In the embodiment in FIG. 1, the dielectric 120 is arranged on an inner surface of the outer electrode 130. The gap is arranged between an outer surface of the inner electrode 140 and dielectric 120.

The dielectric 120 can as well be arranged on the outer surface of the inner electrode 140 (not shown in FIG. 1) so that the gap may be between dielectric 120 and the inner surface of the outer electrode 130. A fluid, preferably a gas, can flow in the gap.

The radial dimensions of the reactor may be chosen in a way that a wave impedance is close or equal to the wave impedance of a cable 210 which can connect reactor elements. As a non-limiting example, with values ∈=4, rᵢ=0.5 mm, r_{d}=1 mm, and rₒ=2 mm, a wave impedance of a cable 210 results to Z=\sqrt{L′/C′}≈70Ω, which is close to 75Ω, a commonly known value for characteristic impedances in commercially available cables.

Since the wave impedance of the DBD plasma reactor elements or modules may be matched to the wave impedance of a connecting cable 210, reflections at the connection point between cable 210 and reactor elements are minimized.

Energy fed into the reactor from a high-voltage pulse generator 240 in form of a discharge impulse is therefore used very efficiently with this approach. Reflections of the pulse at connection points between reactor elements or reactor modules with a connecting cable 210 are mitigated.

In the discussed cases, the wave impedance of the reactor matches the impedance of the connection cable (transmission line) from the pulse voltage source. Additionally, one may use standard impedance matching techniques (as lambda/4 or lambda/12 (Bramham) matching.

E.g. the “Twelfth-Wave Bramham Transformer” may be a more convenient alternative to the more well-known quarter-wave transformer. With the quarter-wave transformer, two impedances Z1 and Z2 are matched by using a quarter-wave of transmission line of characteristic impedance Z=\sqrt{Z1*Z2}. This works well, but may require a non-standard characteristic impedance. For example, to match a 50-ohm load to 75-ohm cable, a quarter-wave transformer needs a length of cable of characteristic impedance 61.2 ohms.

With the twelfth-wave transformer, two lengths of cable are used in series, each electrically nearly one twelfth-wavelength, but of characteristic impedances equal to the two impedances Z1 and Z2 being matched.

Also, transmission line transformers, flux linked transformers or stubs may be used, in order to fully transfer the power from the connecting cable to a reactor, simply by inserting the respective matching.

The described methods allow to change the impedance of the connecting circuit in a certain range. In general, the plasma reactor then has to be configured to match (see conditions for the impedance above) this impedance, i.e. it has to be configured such that a predetermined characteristic impedance is achieved.

Furthermore, the reactor may be terminated with a high impedance (open end) and the voltage pulse that is traveling along the reactor is reflected at its end, thereby providing the possibility to substantially double the voltage on the line.

Another embodiment of the present application may disclose a plasma reactor according to one or more embodiments of the present application, wherein each of the one or more plasma reactor modules or elements may have a specific predetermined length.

The length of each of the plasma reactor modules or reactor elements may be different. This may depend on the kind of species which have to be generated. In this respect, a plasma reactor according to the present application consisting of plasma reactor elements can be adjusted to specific needs in an optimized way.

A characteristic impedance of the plasma reactor module 100, may be preferably a same among the plasma reactor modules, but it may not be necessary that their length is the same. In other words, a plasma reactor may consist of N plasma reactor modules or elements, wherein each module 100 having preferably a same characteristic impedance, but each of the plasma reactor modules has a different length.

Because the wave impedance of the reactor is matched to the wave impedance of the cable 210, reflection at the interface between cable 210 and reactor are minimized.

This may have the advantage, that it is not necessary, that the pulse generator 240 delivers an output voltage which is directly high enough to ignite a plasma. The pulse, running to an end of the reactor and a reflected pulse superimpose to a pulse height, which is substantially double the height of the pulse, originally generated by the voltage pulse source. When the pulses (running and reflected pulse) superimpose, the resulting voltage on the cable doubles.

In another embodiment, a cable may be connected at the end of the DBD reactor and the cable is short-circuit at its end. This would lead to the reflection of a negative pulse. Thus, for every generated pulse, the reactor may see two pulses of opposite polarity.

In other words, using of a short-circuit at the end of a cable, connected to the end of the reactor creates bipolar pulses from a unipolar power supply. A positive pulse, propagating through the reactor can be followed by a negative pulse, running from the end of the reactor to the entry. So, less switches are needed. Species can be generated from one starting pulse with different polarities of the subsequent discharges.

Due to the discharge in the gap between electrode and dielectric, the electric pulse is changing (degrading) as it travels along the length of the plasma reactor (shape, length and voltage may change). To counteract this and to improve efficiency, a geometry (e.g. the thickness of the dielectric layer) can preferably change continuously to adjust to the changing pulse. Such change can also be helpful if e.g. cooling requires less discharges towards the ends of the reactor. In this area, the gas has already heated up, which may negatively influence generation of active species. A standard magnetic compression may also be used to influence the high-voltage pulse.

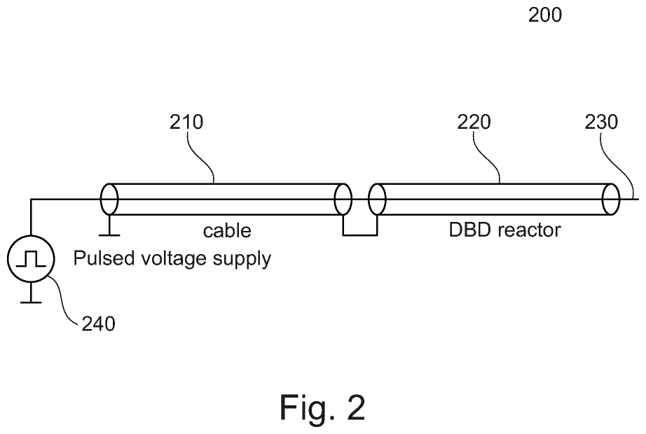

Another embodiment of the present application may disclose a plasma reactor according to one or more embodiments of the present application, wherein one or more of the plasma reactor modules 100 are configured to be connectable to a pulse generator 240 with one end. FIG. 2 discloses a reactor module 220 which is connected to a pulsed voltage supply 240 by a cable 210.

An electrical circuit is shown in FIG. 2. A pulsed voltage from a pulse voltage source with fast rise- and fall times is fed into a cable 210 having a defined wave impedance (typically 50Ω or 75Ω). The output of the cable 210 is directly connected to one side of the reactor and the other side is electrically terminated with a high impedance or left open.

In the arrangement, in FIG. 2, the DBD reactor may comprise only one module 220. More reactor modules 220 may be switched in series by additional cables 210, preferably coaxial cables with a predetermined characteristic impedance. The cables 210 and the DBD reactor 220 may preferably have a same characteristic impedance so as to avoid reflections of a voltage pulse on connection points between a reactor module and the cable.

The length l, of a plasma reactor module, may be the length in which a reaction, e.g. between energy being fed into the reactor as a high-voltage pulse and e.g. a gas, takes place, to generate an activated species.

Such species may be for example, but not limited to, ozone (O3), nitrogen oxides (NOx), or other species with a biocide characteristic, to decontaminate, for example ballast water.

The operating voltage may be chosen such that an ignition voltage for a discharge is between an applied voltage and twice the applied voltage. Discharges are only ignited from the reflected pulse and no undesired reflection due changing impedance, caused by the discharge, can occur when coupling in the pulse.

To maximize production of active species, a DBD is preferably ignited in the entire discharge volume (gas reaction length). Thus, the pulse length lₚᵤₗₛₑ=vₚᵤₗₛₑtₚᵤₗₛₑ should preferably be at least twice as long as the reactor. In other words if e.g. the reactor is 10 m long the pulse length should preferably correspond to 20 m.

Ignition offered discharge is achieved by a voltage pulse with sufficiently high-voltage. A voltage pulse, reflected at the end of the plasma reactor, maybe reflected in a way that a voltage doubling by reflection at the end occurs. Alternatively, the incoming pulse (from the pulse generator 240) can already be sufficient to generate/ignite a discharge.

A plasma reactor according to one or more aspects of the application may be disclosed, wherein a sum of a single length of plasma reactor modules 100, which can also be referred to “element length”, in a series connection of plasma reactor modules 100, 210, 220 may define a total length of the plasma reactor. The reaction length of the plasma reactor is the length, in which a chemical reaction in the plasma reactor takes place. Preferably, the reaction length of the plasma reactor may be defined by the total length, which may be the sum of the length of all reactor elements or modules being switched in series.

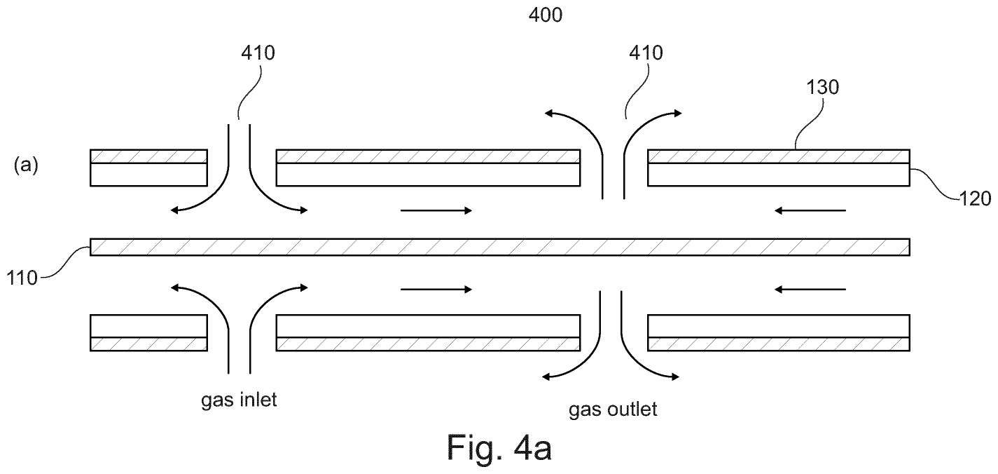

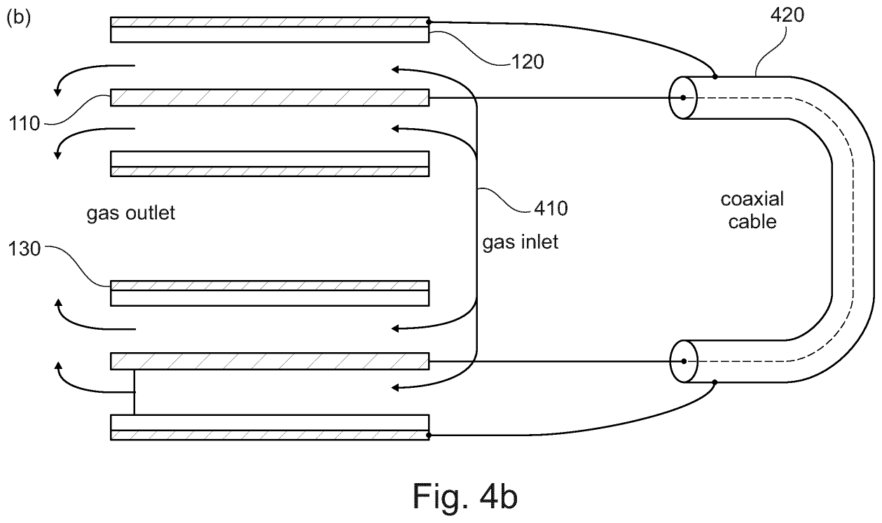

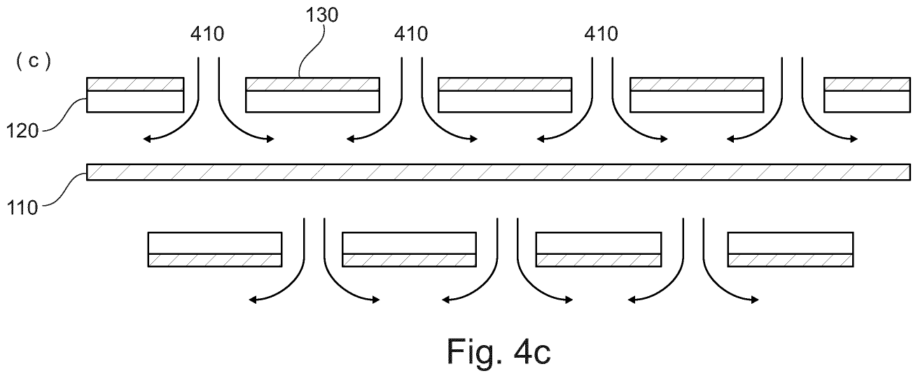

Every single plasma reactor module or reactor element may define its own reaction length, the sum of all these single reaction lengths may define a total reaction length of the plasma reactor. FIG. 4B shows two reactor modules coupled by a coaxial cable 420.

Both reactor modules are arranged substantially parallel in this figure, which should only serve as an exemplary arrangement. Each module has its own reaction length, but as the arrangement is kind of a “folded” arrangement, the total geometrical length of the reactor may be smaller than an unfolded length. In other words, this arrangement may allow for a compact direct barrier discharge reactor size, with no or few compromises in the reaction length.

In particular, FIG. 4B may additionally disclose a concentric electrode arrangement, wherein 110 may be an inner or first electrode of the DBD reactor and 130 may be a second or outer electrode. Other variants may be possible, e.g. flat electrodes. In this respect, multiple smaller reactors with axial flow of the feed gas, arranged in parallel, connected electrically in series with coaxial cables 210 are possible.

Plasma reactor modules may also be arranged in an electrically parallel manner. This may change an input impedance accordingly. From an electrical point of view, the input impedances of two or more reactor modules or reactor elements may thereby form a parallel circuit. This can be important to match to the output impedance of connecting cable.

Another embodiment of the present application according to one or more aspects of the application may disclose a plasma reactor, wherein a physical (geometrical) length of the plasma reactor is shorter than the sum of a length of all plasma reactor modules in series connection.

In other words, a plasma reactor length may be a physical length of the reactor which can be shorter than the total length, if multiple plasma reactor elements or modules are stacked or folded. This may enable, that a normally very long reactor of a known type, can be built geometrically much shorter thereby having substantially the same or very similar gas transition or reactor length. In this way, a geometrically short plasma reactor for a DBD system may have similar characteristics for producing active species than a normal long build reactor.

The total length L (sum of the length of the elements) in general is determined by the requirements of the application (e.g. the amount of active species to be generated); then the pulse duration t of the electrical signal may be chosen to match the reactor length so that it is t=2*L/vₚᵤₗₛₑ or 20*L/vₚᵤₗₛₑ>t>0.5*L/vₚᵤₗₛₑ, wherein vₚᵤₗₛₑ is the propagation speed of the electrical pulse in the reactor

In a further embodiment a plasma reactor according to one or more aspects of the present application discloses that at least one of the one or more plasma reactor modules may preferably have the same characteristic impedance as the pulse generator 240. This may enable, that energy from the pulse generator 240 is not reflected back from the plasma reactor or from the plasma reactor modules but is completely fed into the plasma reactor.

In an alternative embodiments, the pulse generator 240 may not necessarily be matched to the cable/reactor impedance.

A further embodiment discloses a plasma reactor according to one or more aspects of the present application, wherein an electrical connection between the plasma reactor modules to provide a series connection is made with cables 210 (lines), the cables 210 having substantially a same or very similar characteristic impedance as the plasma reactor modules.

The cables 210 (lines) may also be used to connect one side of the DBD reactor to the voltage pulse source. Z_{cable} is a wave impedance of the cable. Z_{cable} is typically in the range of 1Ω to 1000Ω and, in particular it may be that, Z_{cable}=50Ω or Z_{cable}=75Ω or Z_{cable}=95Ω. An output impedance of the pulse generator 240 which is two times the line (cable) impedance may also be possible as well as 0 ohm impedance or near 0 ohm impedance at the output of the pulse generator 240.

In a further embodiment, a plasma reactor according to one or more aspects of the application may be disclosed, wherein an electrical structure of the plasma reactor modules 100 and the electric cables 210, 420 correspond to a wave guide. In yet a further embodiment, values of geometric dimensions of the one or more plasma reactor modules are configured such, that a predetermined characteristic impedance for each of the reactor modules or elements is obtained.

In a further embodiment, a plasma reactor according to one or more aspects of the application is disclosed, wherein the wave-guide structure is a coaxial structure. FIG. 1 shows a coaxial structure of a plasma rector module according to the present application.

Instead of a cylinder concentric arrangement, like coaxial arrangement, also elongated rectangular beams or other arrangements (e.g. plate-knife) of the electrodes are possible—they are typically extrusions of a 2d shape into the propagation direction.

In yet a further embodiment, a plasma reactor according to one or more aspects of the previous application is disclosed, wherein the characteristic impedance of a plasma reactor module 100 or the plasma reactor may be dependent on values of one or more from the group: radial dimension, dielectric, gap size. The radial dimension, dielectric thickness, gap size are chosen such that a resulting characteristic impedance may match the characteristic impedance of cables, connecting the plasma reactor modules.

In a further embodiment, the plasma reactor according to one or more aspects discloses that the one or more plasma reactor modules may have a gas transition length. The gas transition length is a length between an inflow or inlet 410 of a fluid, arranged at a first side of the plasma reactor module, and an outflow or outlet for the fluid, arranged at a second side of the plasma reactor.

Said differently, a gas transition length is the length that a volume element of a fluid, which is fed in the DBD reactor, travels through the gap of the DBD reactor, during which it is enriched with active species. This gas transition length may be equal to a total length of a reactor or a reactor module/element or a fraction of it. It is important to note—as seen in the depicted embodiments—that even though the electrical connection of the reactors is typically serial, the gas flow pattern can be completely different. Fluids can preferably be io specific gases like oxygen (O2), nitrogen, (N2) or normal air.

Normal air e.g. may consist of about 21% oxygen and 78% nitrogen. Adapting operation parameters of the plasma reactor of the present application, may enable that different active species like ozone (O3) or nitrogen oxide (NOx) can be generated from normal air. This may save costs arising from usage of pure gases like oxygen or nitrogen have to be supplied by specific additional pressure gas containments. Pure gases from extra containments may be used as well.

To generate a specific species, a fluid, preferably a gas like oxygen, environmental air or nitrogen, is fed into a discharge volume (gap between electrodes and dielectric) in the plasma reactor. The discharge volume is preferably arranged in an area between an electrode and a dielectric (gap).

At normal conditions a peak voltage larger than 5 kV is sufficient to ignite DBDs and to produce active species. To maximize the output of active species and to minimize the energy consumption, the pulse duration is chosen according to the length of the reactor, so that l<vₚᵤₗₛₑtₚᵤₗₛₑ<10 l. The maximum current that should be supplied by the voltage source may be dependent on the voltage and the wave impedance of the cable. It does not depend on the length (size) of the reactor.

Thus, DBD reactors of different lengths (sizes) can be operated with the same current, and only the pulse duration has to be adjusted according to the reactor length. Another advantage of this solution is that no matching circuit/element is needed to match the power source to the reactor.

Furthermore, a total amount of generated active species is adjusted by the reactor length. For this invention, the reactor does not necessarily have to be along a straight line, it is only important to keep the wave impedance constant. For large-scale applications the necessary reactor length can exceed 100 m. For long reactors, it can be advantageous to bend the reactor or to split it in multiple segments to fit into the available space. These segments can be connected by standard coaxial cables 210 with substantially the same impedance without causing additional losses.

In yet a further embodiment, a plasma reactor according to one or more aspects of the application is disclosed, wherein a total gas transition length of the plasma reactor is equal io to the total length of the plasma reactor or a fraction of the total length of the plasma reactor. The one or more plasma reactor modules may have more than one inflows 410 and more than one outflows 410 (see FIG. 4c) for a fluid between the first side and the second side.

For a long DBD reactor, which may be up to 100 m or more, it can be favorable to split a total gas flow into multiple (smaller) gas flows and to guide each of the smaller gas flows through individual segments of the reactor. Therefore, even though the reactor segments are connected in series electrically with respect to propagating voltage pulses, the gas connection of respective segments may be in parallel. FIGS. 4a to 4c shows some variants.

FIGS. 4a and 4c show examples of variants for the gas flow inside the reactor according to embodiments of the application; here shown for a concentric electrode. Different alternatives may be possible. The gas flow in FIG. 4a is an essentially axial gas flow; the gas flow in FIG. 4c is an essentially radial gas flow. Whether the gas flow can be considered as radial or axial depends on the dimensions. (e.g. relation of distance between in-/outflows of gas/species, diameter/radius of the reactor).

More gas in-/outflows may enable a better reaction quality in the generation of active species. More outflows may be advantageous, e.g. if the outflow is mixed with another fluid and a good mixing quality is intended. More outflows may decontaminate a greater amount of water in the same time. Pulse characteristics have to be adapted on this.

Whereas a folded reactor, as described further above, may act as a centralized source of active species e.g. ozone, the modular approach also allows to have spatially separate (possibly many meters apart) sources connected only by a coaxial cable. This may be used in applications, where the output is needed at different locations and can then be provided in-situ without need for a long gas tube connections between the locations (possibly example is plasma surface treatment of polymers).

In another embodiment, a plasma reactor according to one or more aspects of the present application is disclosed, wherein the one or more plasma reactor modules may have an individual geometry and wherein the plasma reactor modules may have a same impedance.

It may be necessary for some reasons, that one or more plasma reactor modules or elements in a plasma reactor may be sized differently, e.g. to geometrically fit them into a specific housing.

In special cases it may be helpful to have different sections of the reactor with io different geometry (different length and cross-section/diameter of the reactor modules), but the same impedance, such that due to the different discharge properties in the regions e.g. different chemicals/radicals are produced or local cooling of the discharge can be optimized.

In another embodiment of the disclosure of the present application according to one or more aspects, the plasma reactor may further comprise a network interface for connecting controlling elements of the plasma reactor to a data network. The controlling elements of the plasma reactor may be operatively connected to the network interface for at least one of carrying out a command received from the data network and sending device status information to the data network.

In such a configuration, a plasma reactor with a DBD system, for example arranged in a ship for disinfecting ballast water, may be externally controlled from an outside control institution. According to specific needs, it can be necessary, to adapt the kind and the amount of generated species from an outside accordingly.

In yet another embodiment, a plasma reactor according to one or more aspects may be disclosed, wherein the network interface is configured to transceive digital signal/data between the controlling elements of the plasma reactor and the data network, wherein the digital signal/data may include operational command and/or information about the controlling elements of the plasma reactor or a status of the reactor or the network and further comprises a processing unit for converting the signal into a digital signal or processing the signal.

In summary, the reactor as presented in the current application is built preferably as an elongated device (elongated electrodes) in a preferably coaxial arrangement, having substantially the same or very similar impedance as the cable that is connecting to the high voltage power supply (pulse voltage source).

Very few, preferably no reflections between connection points of cable, pulse voltage source and reactor occur. The presented plasma reactor comprises single plasma reactor modules or plasma reactor elements.

The elements/modules of the plasma reactor may be shaped differently (e.g. different length or different diameter each) but the plasma reactor modules/elements may have substantially the same characteristic impedance.

The presented layout of the reactor geometry can be scaled to different sizes to generate a proper amount of active species. The required amount of active species depends on a respective application. The reactor modules or elements can be switched in series via matched connection cables, preferably transmission lines. Special variants use internal reflection at the end of the reactor to double the voltage. This enables to use a pulse generator 240 with a lower maximum voltage since a reflected wave superimposes with the wave coming from generator 240.

In particular, in a further embodiment, the series connection of the plasma reactor modules 100, 220, may be terminated in a way, that a reflection factor of “+1” or “−1” occurs.

Further, features illustrated or described as part of one embodiment can be used on or in conjunction with other embodiments to yield yet a further embodiment. It is intended that the description includes such modifications and variations.

While the foregoing is directed to embodiments of the disclosure, other and further embodiments of the disclosure may be devised without departing from the basic scope thereof, and the scope thereof is determined by the claims that follow.

1. A plasma reactor for a Dielectric Barrier Discharge (DBD) system, comprising:
one or more plasma reactor modules, wherein
the one or more plasma modules are configured as transmission lines, and wherein:
a duration of a rise-time and/or a fall-time of a voltage pulse, fed into a first end of the one or more plasma reactor modules is shorter than a run-time of the voltage pulse from a first end of the one or more reactor modules to a second end of the one or more reactor modules.

2. The plasma reactor for a Dielectric Barrier Discharge (DBD) system according to claim 1, wherein the plasma reactor modules are configured to be electrically connected to a series connection to provide a scalable plasma reactor with a predeterminable length.

3. The plasma reactor according to claim 1, wherein
one or more of the plasma reactor modules are configured to be connectable to a pulse generator with one end.

4. The plasma reactor according to claim 1, wherein
a sum of a single length of the plasma reactor modules in a series connection of plasma reactor modules defines a total length of the plasma reactor, wherein:
the total length of the plasma reactor is the length, in which a chemical reaction takes place.

5. The plasma reactor according to claim 1, wherein an electrical connection between the plasma reactor modules to provide a series connection is made with cables, wherein the cables having a characteristic impedance which substantially matches the characteristic impedance of the plasma reactor modules.

6. The plasma reactor according to claim 1, wherein values of geometric dimensions of the one or more plasma reactor modules are configured such, that a predetermined characteristic impedance for each of the reactor modules is obtained.

7. The plasma reactor according to claim 5, wherein the electric cables are coaxial cables.

8. The plasma reactor according to claim 1, wherein the series connection of the plasma reactor modules, is terminated such, that a reflection factor of “+/−1” for the high-voltage pulse occurs.

9. The plasma reactor according to claim 1, wherein the one or more plasma reactor modules having a gas transition length;
the gas transition length is a length between an inflow for a fluid, arranged at a first side of the plasma reactor module, and an outflow for the fluid, arranged at a second side of the plasma reactor.

10. The plasma reactor according to claim 9, wherein the total gas transition length of the plasma reactor is equal to the total length of the plasma reactor or a fraction of the total length of the plasma reactor.

11. The plasma reactor according to claim 1, wherein;
the one or more plasma reactor modules have additional inflows and outflows for fluid between the first side and the second side.

12. The plasma reactor according to claim 1, wherein the one or more plasma reactor modules can have an individual geometry and wherein
the plasma reactor modules have a substantially same characteristic impedance.

13. The plasma reactor according to claim 1, further comprising a network interface for connecting controlling elements of the plasma reactor to a data network, wherein
the controlling elements of the plasma reactor are operatively connected to the network interface for at least one of carrying out a command received from the data network and sending device status information to the data network.

14. The plasma reactor according to claim 13, wherein the network interface is configured to transceive digital signal/data between the controlling elements of the plasma reactor and the data network, wherein
the digital signal/data include operational command and/or information about the controlling elements of the plasma reactor or a status of the reactor or the network and further includes a processing unit for converting the signal into a digital signal or processing the signal.

15. The plasma reactor according to claim 2, wherein an electrical connection between the plasma reactor modules to provide a series connection is made with cables, wherein the cables having a characteristic impedance which substantially matches the characteristic impedance of the plasma reactor modules.

16. The plasma reactor according to claim 2, wherein values of geometric dimensions of the one or more plasma reactor modules are configured such, that a predetermined characteristic impedance for each of the reactor modules is obtained.

17. The plasma reactor according to claim 2, wherein the electric cables are coaxial cables.

18. The plasma reactor according to claim 2, wherein the series connection of the plasma reactor modules, is terminated such, that a reflection factor of “+/−1” for the high-voltage pulse occurs.
